(19) United States
(12) Patent Application Publication
(10) Pub. No.: US 2026/0225731 A1
(43) Pub. Date: Aug. 6, 2026

(54) METHOD FOR UNLOADING LOAD CARRIERS, AND UNLOADING SYSTEM

(71) Applicant: Siemens Logistics GmbH, Nürnberg (DE)

(72) Inventors: Bengt Mueck, Nürnberg (DE); Christian Schwinge, Fürth (DE)

(21) Appl. No.: 19/149,613

(22) PCT Filed: Jan. 15, 2024
(86) PCT No.: PCT/EP2024/050771

§ 371 Date: Jul. 21, 2025

(30) Foreign Application Priority Data
Jan. 31, 2023 (EP) 23154289.5
Mar. 13, 2023 (EP) 23161544.4

(51) Int. Cl. B64F 1/36; B07C 3/08

(52) U.S. Cl. CPC B64F 1/368; B07C 3/087

(57) ABSTRACT

Until now, the process of unloading piece goods from load carriers has required specially configured mono-functional tilting devices. A multi-functional unloading system and to a method for unloading load carriers now replace the mono-functional tilting devices. The method includes receiving the load carrier together with piece goods via a loading device, moving the load carrier to an unloading region arranged above a target position, and inclining the load carrier about an inclination axis to an inclination angle by the loading device. The inclination angle is selected such that the piece goods slide from the loading device to the target position. The piece goods are slid to the target position via a slide arranged between the load carrier and the target position and above the target position. The slide is arranged at the same inclination angle or a similar inclination angle, and the load carrier is deposited by the loading device.

The present invention relates to the technical field of conveying systems for load carriers loaded with discrete items, in particular, for the unloading of the discrete items from said load carriers. In particular, the invention relates to airport baggage conveying systems in which baggage items are transported in baggage trays.

This application claims the priority of European patent application 23 154 289.5, “Method and storage system for storing load carriers”.

Many baggage conveying systems in airports are configured as tray-based baggage conveying systems (Individual Carrier Systems (ICS)). The advantage of a tray-based basic system is the consistently uniform shape of the load carriers (baggage trays), by means of which the conveying behavior of all the load carriers is highly uniform, as well as the unique, automated and nearly 100% baggage identification by means of RFID on the (baggage) trays. In addition, the load carriers prevent the jamming of loose parts of the baggage items in the baggage conveying system and the transport is protective of the goods. A further advantage of trays is easy access for loading and unloading, greater achievable conveying speed, uniformity (which permits a standardized and therefore uncomplicated construction of the components, wherein the components must only be configured for the uniform load carriers and not for a high degree of variation between different discrete items). In other domains of logistics also, tray-assisted conveying systems are used in which discrete items are conveyed and temporarily stored in load carriers.

The baggage trays are processed together with their baggage item according to their sorting criterion and are transported to their ultimate destination in the baggage tray. These ultimate destinations are typically baggage carousels at the baggage claim or belt conveyors before their loading into aircraft. In most cases, the baggage items are manually fetched at these dispatch locations. In these cases, the baggage items are unloaded from the baggage tray onto a belt system. The unloading of baggage items from a baggage tray typically takes place by tilting or rotating one of the conveyors and, for this purpose, a plurality of variants of a tilting apparatus are known. Each of these variants requires space and connecting infrastructure to the remainder of the conveying system and is thus associated, for each tilting position, with complexity on installation and during operation.

In addition, some baggage items must be held in an early baggage store (EBS). A typical solution for this is to store the baggage tray together with the baggage item in a fixed shelving system within a store. The baggage trays are moved into and out of the shelving system with specialized transport machines (e.g. a storage and retrieval machine). In a development (as described in EP23154289.5), the baggage trays together with their baggage items are removed and placed in a shelving system compartment by a robot (loading apparatus). The shelving systems can be brought by a driverless transport vehicle (automated guided vehicle (AGV)) to a storage location. Whenever a baggage item has to be removed from the early baggage store, an AGV moves the shelving system back to the robot, which then loads the baggage tray together with the baggage item back onto the conveyor system.

In order to transport a baggage item from an early baggage store to a final destination in the conveying system, the transport of the shelving system to the robot, the movement of the baggage tray together with the baggage item (final sorting) and the use of a tilting mechanism are needed. These tilting mechanisms are typically situated outside the main transport route. Thus, aside from the pure tilting mechanism, a rerouting system, an accumulating conveyor and a merging system are required. Direct access to baggage items also takes place in the described manner for other uses.

Conventionally, (intermediate) storage in the early baggage store and final sorting are implemented as separate processes which each require different, mostly monofunctional apparatuses: baggage items are sent from an early baggage store into the tray-based sorting system and unloaded where they are needed. For this purpose, baggage trays with variants of specialized tilting machines are tilted. And the loading and unloading of baggage trays takes place with special storage and retrieval devices.

The present invention is therefore based upon the task of providing a solution for the unloading of load carriers which is both flexible and also uncomplicated in relation to its structure and operation. This object is achieved by way of the solutions disclosed in the independent claims.

The invention is not restricted to airport baggage conveying systems, but rather is suitable for all the conveying systems in which discrete items are conveyed in upwardly open load carriers.

The solution according to the invention provides a method for unloading uniform load carriers loaded with discrete items, in particular, baggage trays loaded with baggage items, wherein the discrete items have an associated sorting criterion, said load carriers being able to be uniquely identified and to be associated with a sorting criterion. The method has the method steps:
a) Receiving the load carrier together with the discrete item by way of a loading apparatus.
b) Moving the load carrier by way of the loading apparatus to an unloading region arranged above a target position determined by way of the sorting criterion.
c) Inclining the load carrier about an inclination axis as far as an inclination angle by way of the loading apparatus, wherein the inclination angle is selected such that the discrete item slides out of the loading apparatus to the target position.
d) Sliding the discrete item to the target position via a chute arranged between the load carrier and the target position and above the target position, wherein the chute is arranged at the same or a similar inclination angle.
e) Depositing of the load carrier by way of the loading apparatus.

With regard to an apparatus, the aforementioned task is achieved with an unloading system for unloading uniform load carriers loaded with discrete items, in particular, baggage trays loaded with baggage items, comprising a loading apparatus and a chute. The discrete items have an associated sorting criterion, the load carriers are uniquely identifiable and can be associated with a sorting criterion. The loading apparatus is configured to receive and deposit the load carrier with or without a discrete item. The loading apparatus is configured for moving the load carrier by way of the loading apparatus to an unloading region situated above a target position determined by way of the sorting criterion. The loading apparatus is configured for inclining the load carrier held by the loading apparatus about an inclination axis as far as an inclination angle, wherein the inclination angle is selected such that the discrete item slides out of the loading apparatus to the target position. The chute is arranged at the same or a similar inclination angle situated between the load carrier and the target position and above the target position and has a sliding surface that is configured for sliding the discrete item as far as the target position.

This means that the following advantages can additionally result: the load carriers serve as containers which are moved by a corresponding tool of the loading apparatus (robot or suchlike). Systems with load carriers provide uniformity in baggage conveying, permit more reliable operation, higher speeds and an improved throughput. Since all baggage items remain completely within their load carriers during the entire baggage conveying process, the risk of damaged baggage items and system disturbances (e.g. caused by jammed carriers or suchlike) is low.

A load carrier within the meaning of the invention should be understood, in particular, to be a tray, more particularly, a baggage tray which typically permits access from above and thereby an uncomplicated loading and unloading. The discrete items are provided with an identifier, in the case of baggage items, typically, a baggage label. In the case of baggage items, the sorting criterion is typically the flight, although the processing time or another criterion (e.g. passengers also traveling) can also be used. The reach of the loading apparatus is dependent upon the reach of a robot arm of the loading apparatus. The load carrier can be unloaded by way of inclining and this requires no, or only a slight, lateral delimitation of the load carrier. If the discrete item slides, the support surface on the load carrier before the unloading and on the target position after the unloading match one another. This is more protective of the goods than a rotation or an uncontrolled tilting (out) of the discrete item, which occurs at very large inclination angles of the load carrier. The inclination angle includes the horizontal and the support surface of the load carrier. It is useful to specify, as the inclination angle, the angle at which the majority of all discrete items with which the load carrier is loaded slides. At too low an inclination angle, the friction is not even overcome, so that the sliding of the discrete item out of the load carrier is not yet initiated. The selection of a larger inclination angle is less protective of the goods. According to one embodiment, the inclination angle of the chute can be dynamically adapted to the inclination angle of the load carrier.

The chute inclination angle approximately corresponds to the load carrier inclination angle or is preferably slightly less, so that no unnecessarily severe further acceleration occurs that is not protective of the goods. Since the discrete item is already in motion on contact with the chute, a chute inclination angle that is less than the load carrier inclination angle can suffice. According to one embodiment, the chute inclination angle can also be larger than the load carrier inclination angle, in particular, if the load carrier inclination angle is set dynamically (by inclining until the discrete item slides), whereas the chute inclination angle has been firmly set.

The chute serves a plurality of aims: it enables the continuous sliding of the discrete item between the load carrier and the target position. In the case of a moving target position on a conveyor, in the event of a direct unloading without a chute through the discrete item being already conveyed away but still in contact with the load carrier, forces would simultaneously act upon the discrete item and transfer to the loading apparatus, the discrete item being still in contact with the loading apparatus. The loading apparatus would have to be configured stabler and damage could be caused to the goods. In order to prevent this, in the absence of a chute, the conveyor would need to be stopped, with a corresponding reduction in throughput.

The load carrier can be received from a conveyor or from an unmoving receiving position, for example, out of a shelving system compartment.

The unloading system has the same advantages, insofar as they are transferrable, that have been set out with regard to the method described. The embodiments set out in the subclaims are each able to be combined individually and in any suitable desired combination, with the method according to the invention and the unloading system according to the invention. Thus method features are formulated herein as a property of the corresponding apparatus unit and vice versa. These embodiments and the advantages associated with them are considered below.

In order to initiate a sliding of the discrete item out of the loading apparatus, including at a small inclination angle, according to one embodiment, a movement, in particular, an abrupt movement of the load carrier by way of the loading apparatus can take place with a movement component contrary to the sliding direction. Through the use of the inertia of the discrete item, the inclination angle does not have to be increased in order to initiate the sliding. A larger inclination angle would also accelerate the discrete item more strongly and would be less protective of the goods. Thus, according to one embodiment, the loading apparatus can be configured to move the load carrier, in particular, abruptly with a movement component contrary to the sliding direction.

According to a further embodiment, a shaking of the load carrier by the loading apparatus can take place in order to initiate a sliding of the discrete item out of the loading apparatus. For this purpose, the loading apparatus can be configured to shake the load carrier.

According to one embodiment, the target position can be on a conveyor, wherein the conveyor can transport the discrete item with a movement component transverse to the sliding direction and can be configured for this purpose.

In order to achieve a good utilization of the unloading region, according to one embodiment, a movement of the entirety, and/or only a portion, of the loading apparatus along the conveyor can take place, while a sliding of the discrete item out of the load carrier is initiated, wherein the entirety and/or only a portion of the loading apparatus can be configured for this purpose. Since the unloading position is moved by the conveyor, the unloading position can thus be reached more accurately and sliding of the discrete item along the conveyor when it arrives on the conveyor is lessened due to its inertia.

According to a further embodiment, a detection of a position of a further object, in particular, a further discrete item on the conveyor and a selection of a target position can take place dependent upon the detected position. For this purpose, the unloading system can comprise a detection unit configured for detecting the position and a control system configured for selecting the target position. In this way, a collision of the discrete item with other objects can be prevented and also a spacing from these other objects can be set.

According to a further embodiment, in addition, the receiving of a further load carrier together with a discrete item by the loading apparatus can take place in an unloading region and a depositing of the load carrier together with the discrete item by way of the loading apparatus can take place in a depositing region, wherein the depositing region can, but does not have to, match the unloading region. For this purpose, the loading apparatus can be configured for the depositing of the load carrier together with the discrete item at a depositing position in a depositing region, wherein the depositing region can, but does not have to, match the unloading region. This enables a multifunctionality both for unloading the discrete items from the load carrier and also for repositioning loaded load carriers so that with the same loading apparatus as the functional unit, new layout configurations of the conveying system are possible. In the depositing region, according to one embodiment, there can be a plurality of depositing positions.

According to a further embodiment, the depositing position can be a shelving system compartment of a shelving system, wherein the shelving system can be able to be displaced by way of a driverless transport vehicle out of the depositing region into a storage region. The shelving systems can be utilized as stores, wherein the same loading apparatus acts as a storage and retrieval device and for unloading the loading apparatus. This embodiment enables the combination of a flexible intermediate store (early baggage store) with a terminus of the conveying system that requires an unloading functionality (e.g. baggage delivery carousel or loading site).

According to a further embodiment, the loading apparatus can slowly incline the load carrier, wherein continuously or incrementally before reaching a maximum specified inclination angle, a further movement of the load carrier (pulling away or shaking) can take place in order to initiate the sliding of the discrete item out of the load carrier. In this way, tilting occurs only to the extent needed and the unloading is thus particularly protective of the goods.

According to a preferred embodiment, the loading apparatus can be configured as a multi-axis robot, so that a particularly high level of flexibility can be achieved. In addition, parts of the robot arm also have components that can be telescopically extended or shortened so that abrupt movements can be carried out particularly easily.

Embodiments of the invention will now be described below in greater detail by way of examples, making reference to the drawings. In the drawings:

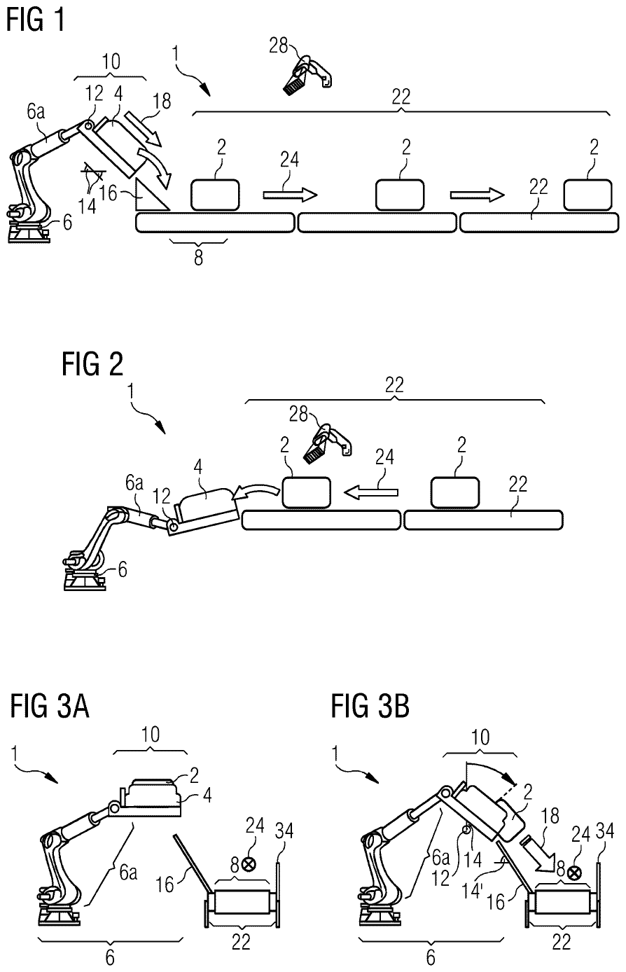

FIGS. 1, 3, 4 show processes of unloading a discrete item from a load carrier of an unloading system according to the invention with a loading apparatus;

FIG. 2 shows a loading procedure with the same loading apparatus;

FIG. 5 shows a conveying system with a loading apparatus according to the invention which both repositions loaded load carriers and also unloads discrete items from load carriers.

The embodiments of the apparatus and the method described below relate, by way of example, to an unloading system 1 in an airport, although all the embodiments are also usable for other types of unloading systems 1 in the field of logistics. Thus, in each of the embodiments set out below, the expressions baggage item 2 and baggage tray 4 are replaced with the more general terms discrete item 2 and load carrier 4/tray 4. The conveying systems are configured as tray-based baggage conveying systems in which the baggage items 2 are transported in the entire baggage conveying system in baggage trays 4 which act as load carriers 4. After the unloading, the baggage items 2 can also be transported without baggage trays 4, whereas the early baggage store 30 as a storage system 30 for early baggage is tray-based. The tray 4 serves as a standardized container which is moved by a corresponding tool on the loading apparatus 8. On the basis of the readily additionally procured components that are not dependent upon one another (loading apparatus 6, load carrier 4, chute 16), the unloading system 1 can be extended in an uncomplicated manner, so that the initial investment costs are also low.

FIG. 1 shows an unloading system 1 according to one embodiment of the invention. Initially, a baggage tray (load carrier) 4 together with the baggage item (discrete item) 2 has been received by the loading apparatus 6, for which purpose the loading apparatus 6 comprises a gripping apparatus or a differently configured receiving apparatus.

For the receiving, the load carrier 6 needs only to be situated in the gripping range of the loading apparatus 6 and it is not necessary to introduce the load carrier 4 manually into the loading apparatus. The load carrier 4 can be received from a moving conveyor 22 or from the other site, for example, from a shelving system compartment. Subsequently, the load carrier 4 is positioned by the arm 6a of the loading apparatus 6 into an unloading region 10 arranged above a chute 16 and a target position 8.

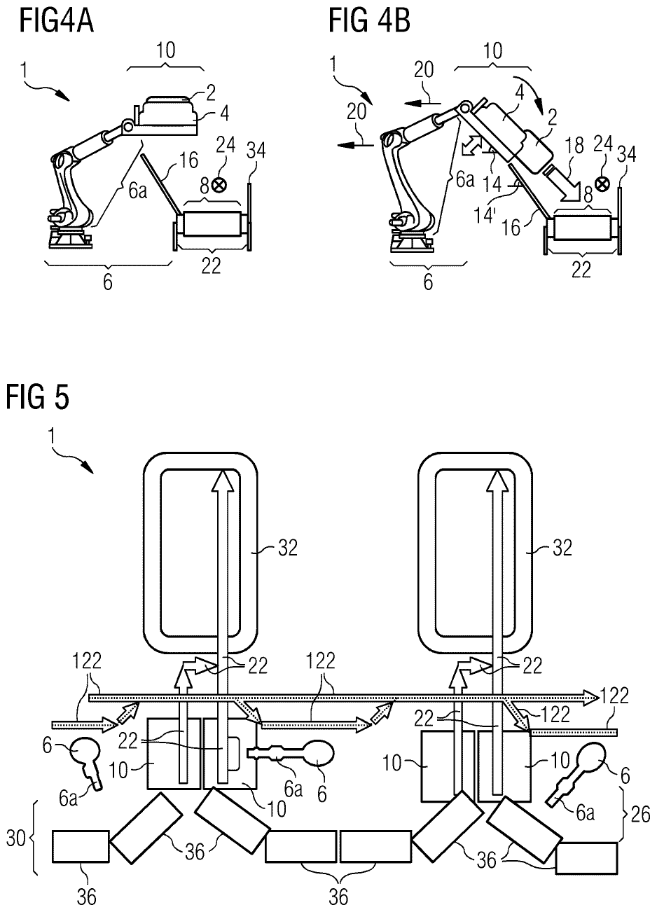

The baggage item 2 is unloaded by the loading apparatus 6, while the loading apparatus 6 holds the baggage tray 4, wherein the unloading of the baggage item 2 takes place onto or from the conveyor 22 in the embodiment of FIG. 1 at a start point of the conveyor 6 (the target position 8 of the unloading of the baggage item 2). Therefore, no lateral delimitation 34 as in the embodiments of FIGS. 3 and 4 is required since a movement component of the sliding direction 18 matches the conveying direction 24 of the conveyor and there is therefore no risk of an uncontrolled sliding of the baggage item 2 over the edge of the conveyor 22. The loading apparatus 6 inclines the baggage tray 4 about an inclination axis 12 as far as an inclination angle 14, so that the baggage item 2 slides over a chute 16 onto the conveyor 22. In the embodiment of FIG. 1, the chute inclination angle 14 and the load carrier inclination angle 14′ match, although this is not essential. After the unloading of the baggage item 2, the loading apparatus 6 puts down the empty baggage tray 4. In order to handle the baggage item 2 according to its sorting criterion following the unloading, the sorting criterion is determined before the unloading.

FIG. 2 shows how, with the same loading apparatus 6, a baggage item 2 can be loaded from a conveyor 22 onto a baggage tray 4. For the loading, the baggage tray 4 held by the loading apparatus 6 is conveyed directly onto the conveyor 22, possibly placed slightly below and the baggage item 2 to be loaded is conveyed into the baggage tray 4. Before the renewed receiving of a further baggage item 2 from the conveyor 22, the loading apparatus 8 receives a further baggage tray 4.

For the unloading and loading according to FIGS. 1 and 2, the incoming and outgoing conveyors 22 can also be arranged directly over one another (with sufficient space therebetween for the baggage items 4a to be transported) or otherwise in direct proximity within the unloading region 10 to be reached by the loading apparatus 6, so that the same loading apparatus 8 can be used for the loading and unloading. For monitoring the loading and unloading, according to a further embodiment, a detection unit 28 included by the unloading system 1 can be utilized, which, given a suitable configuration, can also be used for acquiring the sorting criterion.

FIG. 3 shows the unloading according to yet another embodiment of the invention which is similar to the embodiment shown in FIG. 1. However, the chute inclination angle 14′ is greater than the loading apparatus inclination angle 14. The unloading requires a sliding of the baggage item 2 by way of the inclination of the baggage tray 4 held by the loading apparatus 6. It is possible for each unloading to select a predetermined inclination angle 14 and the selection of the inclination angle 14 therefore takes place dependent upon friction and the friction of the respective specific baggage item 2 that is to be unloaded.

Alternatively, the baggage tray 4 can also only be inclined cautiously (continuously or sequentially) for long enough and far enough, until the baggage item 2 begins to slide.

In addition to a simple rotation for unloading the baggage item 2 as with a conventional tilter, robot loading apparatuses 6 can carry out movements that conventional tilters cannot carry out. By this means, the tilting process can be improved. FIG. 4 shows possibilities according to an embodiment of the invention that can be combined or carried out individually for an additional initiation of the sliding with previously set inclination angles 14, as in FIG. 3. Firstly, the inertia of the baggage item 2 can be utilized in that the loading apparatus 6 abruptly withdraws the load carrier 4 with a movement component 20 contrary to the sliding direction 18. The baggage tray 4 is thus not only tilted/inclined about an axis 12. In parallel therewith, the arm 6a or the entire loading apparatus 6 moves away from the baggage item 2. With this abrupt movement, the baggage item 2 receives an additional acceleration in order for it to leave the baggage tray 4. In comparison with a traditional tilter, the number of not unloaded baggage items 2 is reduced, as also is the space requirement.

In addition to the inclining/tilting, the load carrier 4 can additionally be shaken (double-headed arrow in FIG. 4b) in order to overcome frictional forces. Particularly adhesion-prone baggage items 2, for example, wet leather cases 2, also tend to remain in the baggage tray 4. The shaking also reduces the number of incorrectly unloaded baggage items 2.

In FIGS. 3 and 4, the target position 8 of the unloading is on a conveyor 22 which is driven with a transport direction 24 transverse to the sliding direction 18. The chute 16 ensures that the baggage item 2 is not already conveyed by the conveyor 22 along the transport direction 24 while the baggage item 2 is still in contact with the load carrier 4 and therefore with the loading apparatus 6. As a result, force effects do not act simultaneously upon the arm 6 of the loading apparatus 4 from a plurality of sides. Also arranged laterally to the target position 8 is a side protector 34 which prevents the baggage item 2 falling off the conveyor 22.

EP23154289.5 discloses an early baggage store with robot-loaded shelving systems. Baggage trays 4 loaded with baggage items 2 are transported in the early baggage store in a horizontal position. The robot loading apparatus 2 can reach a plurality of depositing positions in a depositing region 26 for baggage trays 4. According to one embodiment, a portion of the depositing region 26 is changed into an unloading region 10. The loading apparatus 2 takes the baggage tray 4 out of the shelving system 36 or from the conveyor belt 122 and moves it further into the unloading region. The loading apparatus 2 then carries out a tilt movement with the baggage tray 4, whereupon the baggage item 2 slides out of the baggage tray 4. The unloading and the unloading system 1 according to the invention is not restricted to being used in conjunction with an early baggage store 30. Wherever the robot can take up full baggage trays 4 and place empty baggage trays 4, the unloading according to the invention can be utilized.

Both for the additional movements of the loading apparatus 2 as shown in FIG. 4b and also for co-movement of the baggage tray 4, an embodiment of the loading apparatus 2 as a multi-axis robot is advantageous. While parts of the robot arm also have components that can be extended or shortened in telescopic manner, just as co-traveling movements (above the target position of a moving conveyor 22), abrupt movements can also be carried out particularly easily.

FIG. 5 shows a layout configuration of an airport baggage conveying system according to a further embodiment enabled by the invention. On a conveyor 122, baggage trays 4 loaded with baggage items 2 are each transported to robot unloading regions 10 of a loading apparatus 6. Dependent upon their sorting criteria, the baggage items 2 are either unloaded onto a further conveyor 22, wherein it transports the unloaded baggage items 2 to a terminus of the baggage conveying system, for example, a baggage delivery carousel 32. However, the loading apparatus 6 can also deposit a load carrier 4 together with a baggage item 2 in a depositing region 26. Arranged in the depositing region 26 are shelving systems 36 or other storage apparatuses 36 onto which the load carriers 4 are deposited together with the baggage items 2 and, at a later time point, can either be introduced onto the conveyor 122 again and thus into the sorting of the baggage conveying system, or a load carrier 4 together with the baggage item 2 is removed at a later time point by the loading apparatus 6 from the depositing region 26 and the baggage item is subsequently unloaded directly out of the baggage tray 4 by the loading apparatus 6 onto the conveyor 22 to the terminus 32. For the intermediate storage, the shelving systems can be accommodated as described in EP23154289.5 by means of driverless transport vehicles in a storage region.

According to a further embodiment, the entire and/or only a portion of the loading apparatus 6, e.g. the robot arm 6a, can be moved along the conveyor 22, while the loading apparatus 6 tilts the baggage tray 4. For this purpose, the loading apparatus 6, can be moved, for example, on rails beside the conveyor 22. Thus, the target position 8 can be reached more accurately, which is important, in particular, for a sequential setting of the inclination angle 14.

According to a further embodiment, the positions of further objects 2′, in particular further baggage items 2 on the conveyor 22 are sensed by a detection unit 28 and the target position 8 of the baggage item 2 that is to be unloaded is determined dependent upon the position of the objects 2′ already lying on the conveyor 22, for example, by way of the selection of the unloading time point or by way of positioning above the conveyor 22 of the baggage tray 4 that is to be unloaded.

In order to remove individual baggage items 2 manually, apart from the unloading onto a transport band 22, the unloading into a crate or suchlike is also possible.

### REFERENCE SIGNS

1 Unloading system
2 Discrete item, baggage item
4 Load carrier, baggage tray
6 Loading apparatus
6a Robot arm
8 Target position
10 Unloading region
12 Inclination axis
14 Inclination angle
16 Chute
18 Sliding direction
20 Movement component against the sliding direction
22, 122 Conveyor
24 Conveying direction
26 Depositing region for load carrier +discrete item
28 Detection unit
30 Storage region, early baggage store
32 Baggage delivery carousel, discrete item terminus
34 Side protector
36 Shelving system

1-15. (canceled)

16. A method for unloading uniform load carriers loaded with discrete items, wherein the discrete items have an associated sorting criterion, the uniform load carriers being able to be uniquely identified and to be associated with a sorting criterion, which comprises the method steps of:
a) receiving the uniform load carriers together with the discrete items by way of a loading apparatus;
b) moving a uniform load carrier by way of the loading apparatus to an unloading region disposed above a target position determined by way of the sorting criterion;
c) inclining the uniform load carrier about an inclination axis as far as an inclination angle by way of the loading apparatus, wherein the inclination angle is selected such that a discrete item slides out of the loading apparatus to the target position;
d) sliding the discrete item to the target position via a chute disposed between the uniform load carrier and the target position and above the target position, wherein the chute is disposed at a same or a similar said inclination angle; and
e) depositing the uniform load carrier by way of the loading apparatus.

17. The method according to claim 16, which further comprises moving the uniform load carrier by way of the loading apparatus with a movement component contrary to a sliding direction.

18. The method according to claim 16, which further comprises shaking the uniform load carrier by the loading apparatus in order to initiate a sliding of the discrete item out of the loading apparatus.

19. The method according to claim 16, wherein the target position is situated on a conveyor, the conveyor transports the discrete item with a movement component transverse to the sliding direction.

20. The method according to claim 19, which further comprises moving an entirety and/or only a portion of the loading apparatus along the conveyor while a sliding of the discrete item out of the uniform load carrier is initiated.

21. The method according to claim 20, which further comprises:
detecting a position of a further object on the conveyor; and
selecting the target position dependent upon the position of the further object.

22. The method according to claim 16, which further comprises:
receiving a further uniform load carrier together with a further discrete item by way of the loading apparatus in the unloading region; and
depositing the further uniform load carrier together with the discrete item by way of the loading apparatus in a depositing region, wherein the depositing region can, but does not have to, match the unloading region.

23. The method according to claim 16, wherein the uniform load carriers are baggage trays loaded with baggage items.

24. The method according to claim 21, wherein the further object on the conveyor is a further discrete item on the conveyor.

25. An unloading system for unloading uniform load carriers loaded with discrete items, comprising:
a loading apparatus;
a chute, wherein the discrete items have an associated sorting criterion, the uniform load carriers being able to be uniquely identified and to be associated with a sorting criterion;
said loading apparatus configured for receiving and depositing a uniform load carrier with or without a discrete item;
said loading apparatus configured for moving the uniform load carrier by way of said loading apparatus to an unloading region situated above a target position determined by way of the sorting criterion;
said loading apparatus configured for inclining the uniform load carrier held by said loading apparatus about an inclination axis as far as an inclination angle, wherein the inclination angle is selected such that the discrete item slides out of said loading apparatus to the target position; and
said chute is disposed at a same or a similar said inclination angle between the uniform load carrier and the target position and above the target position and has a chute surface that is configured for sliding the discrete item as far as the target position.

26. The unloading system according to claim 25, wherein said loading apparatus is configured for moving the uniform load carrier with a movement component contrary to a sliding direction.

27. The unloading system according to claim 25, wherein said loading apparatus is configured for shaking the uniform load carrier in order to initiate a sliding of the discrete item out of said loading apparatus.

28. The unloading system according to claim 25, further comprising a conveyor, wherein the target position is situated on said conveyor and said conveyor is configured to transport the discrete item with a movement component transverse to a sliding direction.

29. The unloading system according to claim 28, wherein an entirety and/or only a portion of said loading apparatus is configured for moving along said conveyor while a sliding of the discrete item out of the uniform load carrier is initiated.

30. The unloading system according to claim 28, further comprising:
a control system; and
a detection unit configured for detecting a position of a further object on said conveyor and said control system is configured for selecting the target position dependent upon the position of the further object.

31. The unloading system according to claim 25, wherein said loading apparatus is configured for depositing the uniform load carrier together with the discrete item at a depositing position in a depositing region wherein the depositing region can, but does not have to, match the unloading region.

32. The unloading system according to claim 31, wherein the depositing position is a shelving system compartment of a shelving system, wherein the shelving system is capable of being displaced by way of a driverless transport vehicle out of the depositing region into a storage region.

33. The unloading system according to claim 25, wherein the uniform load carriers are baggage trays loaded with baggage items.

34. The unloading system according to claim 30, wherein the further object is a further discrete item.
